(19) United States
(12) Patent Application Publication
(10) Pub. No.: US 2011/0299774 A1
(43) Pub. Date: Dec. 8, 2011

(54) METHOD AND SYSTEM FOR DETECTING AND TRACKING HANDS IN AN IMAGE

(76) Inventors: Corey Mason Manders, Singapore (SG); Farzam Farbiz, Singapore (SG); Jyn Herng Bryan Chong, Singapore (SG); Ka Yin Christina Tang, Singapore (SG)

(21) Appl. No.: 12/988,936

(22) PCT Filed: Apr. 22, 2008
(86) PCT No.: PCT/SG2008/000131

§ 371 Date: May 4, 2011

(51) Int. Cl. G06K 9/46; G06K 9/00

(52) U.S. Cl. 382/168; 382/190

(57) ABSTRACT

A method and system for detecting and tracking hands in an image. The method for detecting and tracking hands in an image comprises the steps of calculating a first probability map comprising of probabilities that respective pixels in the image corresponds to skin based on colour information associated with the respective pixels; calculating a second probability map comprising of probabilities that the respective pixels in the image corresponds to a part of a hand based on depth information associated with the respective pixels; calculating a joint probability map by combining the first probability map and the second probability map; and detecting and tracking hands in the image using an algorithm with a weight output as a detection threshold applied on the joint probability map.

### FIELD OF INVENTION

The present invention relates broadly to a method and system for detecting and tracking hands in an image.

### BACKGROUND

In the concept of a multi-modal user interface, users are able to communicate with computers using the modality that best suits their request. Besides a mouse and a keyboard input, these modalities also include speech, hand-writing and gestures.

With the development of computer technology, the technology of gesture recognition based on vision as a new means of human-computer interaction has been developing quickly. Skin colour has been shown to be a useful and robust cue for face and gesture detection. However, typically when using such methods, people are often required to wear long-sleeved clothing, with restrictions on the colour of the background. Different colour spaces such as RGB, normalized RGB, HSI, YUV and YCrCb are used for skin colour modelling. Various models including single Gaussian, multiple Gaussian and Bayes have been proposed to model the skin colour distribution.

To build a skin-colour model, the conventional method is to first gather face images and subsequently, removes the background and the non-skin areas from each image manually. The following step is to derive a histogram of the colour in the remaining areas in a colour space. By analysing this histogram, a skin-colour model can be built to define a skin colour probability distribution. The model, in general, requires a large amount of training data used to train classifiers. However, the skin-colour model should not remain the same when the lighting conditions or camera parameters vary. For example, this could be when the input video camera is changed, or, when the white balance, exposure time, aperture, or sensor gain of the camera is readjusted, etc. Moreover, a wide range of skin tones is present due to the presence of multiple ethnic groups and this renders simplistic classification infeasible. Therefore, a generic skin-colour model is inadequate to accurately capture the skin colour in different scenarios.

To improve the detection accuracy and reduce the false positive rate, it is preferable to adopt an adaptive skin-colour model instead of a static one. Therefore, it is preferable that the model is able to update itself to match the changing conditions [Vezhnevets V., Sazonov V., Andreeva A., “A Survey on Pixel-Based Skin Colour Detection Techniques”. Proc. Graphicon-2003, pp. 85-92, Moscow, Russia, September 2003]. Furthermore, for the system to be effective, it is preferable that the model training and classification system work in real-time, consuming little computing power.

In [Kai Nickel, Rainer Stiefelhagen, “Pointing Gesture Recognition based on 3Dtracking of Face, Hands and Head Orientation”, Proceedings of the Fifth International Conference on Multimodal Interfaces, Vancouver, Canada, Nov. 5-7, 2003.], the authors presented a system capable of visually detecting pointing gestures and estimating the 3D pointing direction in real-time. They track the positions of a person's face and hands on image sequences provided by a stereo camera. Specifically, the authors look for a person's head in the disparity map of each frame. Pixels inside the region detected as the head contribute to the skin-colour model. However, although the skin colour of the face and the hands are quite similar, there remain some differences between them. Therefore, the model can only be used to provide the skin colour probability for each pixel. As the authors of this prior art detect the user's face and hand by using this model together with morphological processes, a further downfall of this method is that a posture score must be calculated for each new frame whereby the computation of this posture score requires a model of the human body, which has to be built from a large set of training data.

In [S. Grange, E. Cassanova, T. Fong, and C. Baur., “Vision-based sensor fusion for Human-Computer Interaction”, IEEE International Conference on Intelligent Robots and Systems, Lausanne, Switzerland, 2002.], the authors use both depth and skin colour information together to improve segmentation for the purpose of human computer interaction. However, the skin model in this prior art is not adaptive.

In [Kawato S., Ohya J., “Automatic skin-color distribution extraction for face detection and tracking”, ICIP, pp. 1415-1418, August 2000.], Kawato S. and Ohya J. built a skin-colour model for operation while a face detection system is running. When there is no skin-colour model, the system uses the differences between adjacent frames to extract moving objects. Once the system recognizes that the moving object is a face, it will analyse the colour histogram of the moving area and the exact skin-colour distribution. However, this method can only be used for face detection in a small area with the assumption that only a person's face is moving. It cannot be used for interactive display because users may move their entire bodies when communicating with the system.

An adaptive skin detection method with a two-step process was proposed in [Qiang Zhu, Kwang-Ting Cheng, Ching-Tung Wu, Yi-Leh Wu, “Adaptive learning of an accurate skin-color model”, ICAFGR, pp. 37-42, May 2004.]. For a given image, the authors first perform a rough skin classification using a generic skin-colour model which defines the skin-similar space. In the second step, a Gaussian Mixture Model (GMM), specific to the image under consideration and refined from the skin-similar space is derived using the standard Expectation-Maximization algorithm. Next, the authors use an SVM classifier to identify a Gaussian skin model from the trained GMM by incorporating spatial and shape information of the skin pixels. However, a large database of images including skin pixels under various lighting conditions and from different ethnic groups is needed to train this generic skin-colour model. This method also only detects all the skin pixels in the image without classifying which part of the body each skin area belongs to.

Wagner [Wagner S., Alefs B., Picus C., “Framework for a portable gesture interface”, ICAFGR, pp. 275-280, April 2006.] presented a framework for interaction by hand gestures using a head mounted camera system. It uses an AdaBoost cascaded classifier based on edge features to detect open hand gesture to activate the system. Then it uses adaptive mean shift to determine the skin-colour model in YCbCr colour space, and tracks the hand based on this skin-colour model. One problem of this system is that the user has to wear a cap with a camera on it. In addition, the user must make sure that the camera is facing his/her hand when using the system. Thus, it is not convenient to use this method in interactive display applications.

In [Yuan Yao, Miao-Liang Zhu, “Hand tracking in time-varying illumination”, Proc. of 2004 Intl. Conf. on MLC, vol. 7, pp. 4071-4075, 2004.], the authors presented an approach to generate hand segmentation from the video captured by a webcam in time-varying illumination. This approach consists of two parts. The first part of the approach imposes automatic gain control during the video capture. The second part of the approach uses a Markov model to simultaneously estimate and predict the skin colour distribution and camera parameters. However, this approach may fail when the background contains colours similar to the skin colour.

Narcio C. Cabral [Narcio C. Cabral, Carlos H. Morimoto, Marcelo K. Zuffo, “On the usability of gesture interfaces in virtual reality environments”, CLIHC'05, pp. 100-108, Cuernavaca, Mexico, 2005.] discussed several usability issues related to the use of gestures as an input method in multi-modal interfaces. In this method, Narcio trained a simplified skin-colour model in RGB colour space for face detection. Once the face is detected, selected regions of the face are used to adjust the skin-colour model. This model is then used to detect the hands. Kalman filters are then used to estimate the size and position of the hands. Although there is no background problem for this system according to the assumption, tracking by Kalman filters may fail when there is any occlusion. To overcome this problem, the author had to utilize a spatial-temporal hand consistency graph to prevent such failures from interfering too heavily with the tracking.

In [Matheen Siddiqui, Gérard Medioni, “Robust Real-Time Upper Body Limb Detection and Tracking”, Proc. 4th ACM international workshop on Video surveillance and sensor networks, pp. 53-60, Santa Barbara, Calif., USA, 2006.], the authors described a system to detect and track the limbs of a human. They first find the face of a user and then extract the location and colour information from the face to find the limbs. Next, they detect and track the limbs by using edge and colour information. However, this system is limited to 2D applications, and can only run at 10 frames per second.

In [X. Zhu, J. Yang, A. Waibel, “Segementing hands of arbitrary color”, Proc. IEEE Intl. Conf. on Automatic Face and Gesture Recognition (FG 2000), pp. 446-453, March 2000, Grenoble, France.], the authors proposed a statistical approach to hand segmentation based on Bayes decision theory. A restricted EM algorithm is introduced to train an adaptive GMM for still images, whereby the background is modelled by four Gaussian kernels, and the hand colour is modelled by one Gaussian. This modified EM algorithm requires strict prior information, including a good estimation of the hand colour and a reasonable bound of weighted values in order to obtain more robust results. To distinguish the skin component from other Gaussian components, the authors heuristically fixed the mean of the first Gaussian in estimating the hand colour during the training process. In doing so, the ability of the GMM to model the actual skin colour distribution for individual images would significantly degrade. Furthermore, this method can only be applied on still images.

In [Wilson, D., A Demonstration of Touchlight, an Imaging Touch Screen and Display for Gesture-Based Interaction. ACM Symposium on User Interface Software and Technology, Santa Fe, USA, 2004.], a gesture recognition system is presented. In this implementation, information is gained through a touch interface, where a projector projects an image onto a translucent surface and several infra-red (IR) LEDs shine light onto the surface. IR cameras are then used to detect the position of finger touching the translucent screen. Using the system proves to be quite ineffective, and is hence not well suited to providing 3D input.

Although hand gestures are used in [Wilson, A., Oliver, N. “GWindows: Robust Stereo Vision for Gesture-Based Control of Windows”, IEEE International Conference of Multimodal Interfaces, Vancouver, Canada, 2003.], these gestures include one-hand gestures only. Furthermore, the system must be activated by sweeping the hand in a region just in front of the monitor. Also, this interface is intended to be used solely as ah addition to a keyboard and mouse and the gestures must be supplemented by audio commands.

Hence, in view of the above, there exists a need for a system and a method of detecting and tracking hands in an image which seek to address at least one of the above problems

### SUMMARY

According to a first aspect of the present invention, there is provided a method for detecting and tracking hands in an image, the method comprising the steps of calculating a first probability map comprising of probabilities that respective pixels in the image corresponds to skin based on colour information associated with the respective pixels; calculating a second probability map comprising of probabilities that the respective pixels in the image corresponds to a part of a hand based on depth information associated with the respective pixels; calculating a joint probability map by combining the first probability map and the second probability map; and detecting and tracking hands in the image using an algorithm with a weight output as a detection threshold applied on the joint probability map.

The step of calculating a first probability map comprising of probabilities that respective pixels in the image correspond to skin based on colour information associated with the respective pixels may further comprise the steps of detecting a face in the image; calculating hue and saturation values of the respective pixels in the image; quantizing the hue and saturation values calculated; constructing a histogram by using the quantized hue and saturation values of the respective pixels in a subset of pixels from a part of the detected face; transforming the histogram into a probability distribution via normalization; and back projecting the probability distribution onto the image in the hue/saturation space to obtain the first probability map.

The step of calculating hue and saturation components of the respective pixels in the image may further comprise the step of applying the inverse of a range compression function to the respective pixels in the image.

The method may further comprise the step of building a mask for the detected face prior to using the subset of pixels from a part of the detected face to construct the histogram, wherein the mask removes pixels not corresponding to skin from the subset of pixels.

The method may further comprise the step of adding the constructed histogram to a set of previously constructed histograms to form an accumulated histogram prior to transforming the histogram into a probability distribution via normalization.

The method may further comprise the steps of defining the horizontal aspect of a ROI of a right hand to be the right side of the image starting slightly from the right of the face to the right edge of the image; defining the horizontal aspect of a ROI of a left hand to be the left side of the image starting slightly from the left of the face to the left edge of the image; and defining the vertical aspect of a ROI of both hands to be from just above a head containing the face to the bottom of the image and the back projecting of the probability distribution onto the image in the hue/saturation space to obtain the first probability map is performed onto candidate regions of the image corresponding to the ROI.

If a face is not detected, the method may further comprise the steps of checking if the hands are detected in a previous frame; checking if a ROI of the hands is close to a ROI of the face in the previous frame; defining a ROI of the hands in a current frame based on the ROI of the hands in the previous frame if the hands are detected in the previous frame and if the ROI of the hands are close to the ROI of the face in the previous frame; and the back projecting of the probability distribution onto the image in the hue/saturation space to obtain the first probability map is performed onto candidate regions of the image corresponding to the ROI of the hands in the current frame.

The step of calculating a second probability map comprising of probabilities that the respective pixels in the image corresponds to a part of a hand based on depth information associated with the respective pixels may further comprise the steps of calculating a first distance, d_{face}, between a face and a camera; calculating a second distance, dₘᵢₙ, wherein the second distance is the minimum distance an object can be from the camera; calculating a third distance, D, between the respective pixels in the image and the camera; calculating a probability of zero if D is greater than d_{face}, a probability of one if the D is less than dₘᵢₙ and a probability of (d_{face}−D)/(d_{face}−dₘᵢₙ) otherwise for the respective pixels in the image; normalizing the calculated probability by multiplying said calculated probability by (2/(d_{face}+dₘᵢₙ)) for the respective pixels in the image; calculating pixel disparity values resulting from a plurality of cameras having differing spatial locations; and converting the normalized probability into a probability that the respective pixels in the image corresponds to a part of a hand using the pixel disparity values to form the second probability map.

The step of calculating a joint probability map by combining the first probability map and the second probability map may further comprise the step of multiplying the first probability map and the second probability map by using Hadamard product.

The method may further comprise the step of applying a mask over the joint probability map prior to detecting hands in the image, wherein the mask is centered on a last known hand position.

The step of detecting and tracking hands in the image using the algorithm with a weight output as a detection threshold applied on the joint probability map may further comprise the steps of calculating a central point of a rectangle around each of a probability mass along with the angle of each of a probability mass in the joint probability map in this frame; and calculating a position of each of the hands in the X, Y and Z axes as well as the angle of each hand using the calculated central point and calculated angle in this frame, and the calculated central point in the previous frame.

The method may further comprise the step of calculating the direction and velocity of motion of the detected hands using the positions of previously detected hands and the positions of following detected hands.

According to a second aspect of the present invention, there is provided a system for detecting and tracking hands in an image, the system comprising a first probability map calculating unit for calculating a first probability map comprising of probabilities that respective pixels in the image corresponds to skin based on colour information associated with the respective pixels; a second probability map calculating unit for calculating a second probability map comprising of probabilities that the respective pixels in the image corresponds to a part of a hand based on depth information associated with the respective pixels; a third probability map calculating unit for calculating a joint probability map by combining the first probability map and the second probability map; and a detecting unit for detecting and tracking hands in the image using an algorithm with a weight output as a detection threshold applied on the joint probability map.

The system may further comprise an expander for applying the inverse of a range compression function to the respective pixels in the image.

According to a third aspect of the present invention, there is provided a data storage medium having stored thereon computer code means for instructing a computer system to execute a method for detecting hands in an image, the method comprising the steps of calculating a first probability map comprising of probabilities that respective pixels in the image corresponds to skin based on colour information associated with the respective pixels; calculating a second probability map comprising of probabilities that the respective pixels in the image corresponds to a part of a hand based on depth information associated with the respective pixels; calculating a joint probability map by combining the first probability map and the second probability map; and detecting and tracking hands in the image using an algorithm with a weight output used as a detection threshold applied on the joint probability map.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 illustrates a schematic block diagram of a range compression process in the prior arts.

FIG. 2 illustrates a schematic block diagram of a range compression process according to an embodiment of the present invention

FIG. 3 shows a flowchart illustrating a method for tracking hands according to an embodiment of the present invention.

FIGS. 4A and 4B show the HS histograms of the hands and faces from subject 1 and subject 2 respectively according to an embodiment of the present invention.

FIG. 5 shows a schematic block diagram of a system for detecting and tracking hands in an image according to an embodiment of the present invention.

FIG. 6 illustrates a schematic block diagram of a computer system on which the method and system of the example embodiments can be implemented.

FIG. 7 shows a flowchart illustrating a method for detecting and tracking hands in an image according to an embodiment of the present invention.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “determining”, “detecting”, “quantizing”, “constructing”, “transforming”, “back projecting”, “applying”, “building”, “adding”, “normalizing”, “converting”, “multiplying”, “extracting”, “defining” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Embodiments of the present invention include a stereo camera, a display and a standard PC. In one example, the stereo camera is used to capture the user's face and hand and hand gestures are used to provide input into a system. These hand gestures may be used to control a 3D model, be used as input to a game, etc.

In the example embodiments, the Hue-Saturation based colour space (HS space) is used to detect the user's hand motion instead of the RGB colour space. Hue defines the dominant colour of an area, while saturation measures the purity of the dominant colour in proportion to the amount of “white” light. The luminance component of the colour space, is not used in the example embodiments as our aim is to model what can be thought of “skin tone”, which is more controlled by the chrominance than the luminance components.

Typically, cameras capture images using three colour channels, red, green and blue. If there is access to the raw sensor data from the camera, the values collected are typically linear. Hence, if two images are taken of the same object but the sensor array is exposed to the incoming light for twice as long in the second image, one would expect that the raw values would be twice that of the first exposure. The red, green and blue pixel values observed are the result of the linear sensor values r, g and b with the range compression function, f, applied. These red, green and blue pixel values may respectively be referred to as R=f(r), G=f(g) and B=f(b).

When performing skin detection tasks, a colourspace transformation from RGB to HSV is usually performed. Thus, the pixel values f(r), f(g) and f(b) are transformed to hue, saturation and intensity component, with the purpose of separating the intensity component in the colourspace. Once completed, the intensity component will be dropped to allow for intensity differences, while retaining the colour information.

Assuming that a face has been successfully detected and that the range compressed pixel values are used, Equations (1)-(4) show the typical output from a camera, with the output consequentially used for image processing tasks. In Equations (1)-(4), max=max(f(r), f(g), f(b)) and min=min(f(r), f(g), f(b)).

In Equation (1), the hue component is calculated for a first image. When f(max)=f(r), f(g)≧f(b) and f(min)=f(b), the hue component for the first image is given by Equation (2).

Assuming a second image, which is the same image, but differs in exposure time by the ratio k, Equation (3) gives the hue component for this second image when f(max)=f(r), f(g)≧f(b) and f(min)=f(b). In Equation (3), k is the ratio of the exposure time of the second image to the exposure time of the first image. For example, if the exposure time of the first image is 100 ms and the exposure time of the second image is 200 ms, k=2. Hence, given a pixel in the first image, f(g), not accounting for noise, the same pixel in the second image will be f(kg).

$$\begin{matrix}{H}_{1} = \{ \begin{matrix}0 & if max = min \\ {60}^{o} \times \frac{f ( g ) - f ( b )}{f ( max ) - f ( min )} + {0}^{o} & if max = f ( r ) and f ( g ) \geq f ( b ) \\ {60}^{o} \times \frac{f ( g ) - f ( b )}{f ( max ) - f ( min )} + {360}^{o} & if max = f ( r ) and f ( g ) < f ( b ) \\ {60}^{o} \times \frac{f ( g ) - f ( r )}{f ( max ) - f ( min )} + {120}^{o} & if max = f ( g ) \\ {60}^{o} \times \frac{f ( r ) - f ( g )}{f ( max ) - f ( min )} + {240}^{o} & if max = f ( b )\end{matrix} & ( 1 ) \\ {H}_{1} = {60}^{o} \times \frac{f ( g ) - f ( b )}{f ( max ) - f ( min )} = {60}^{o} \times \frac{f ( g ) - f ( b )}{f ( r ) - f ( b )} & ( 2 ) \\ {H}_{2} = {60}^{o} \times \frac{f ( kg ) - f ( kb )}{f ( kr ) - f ( kb )} & ( 3 )\end{matrix}$$

H₁ would only be equal to H₂ if f is linear as shown in Equation (4).

$$\begin{matrix}{H}_{2} = {60}^{o} \times \frac{f ( kg ) - f ( kb )}{f ( kr ) - f ( kb ) } \\ = {60}^{o} \times \frac{kf ( g ) - kf ( b )}{kf ( r ) - kf ( b )} \\ = {60}^{o} \times \frac{f ( g ) - f ( b )}{f ( r ) - f ( b )} \\ = {H}_{1}\end{matrix} \qquad ( 4 )$$

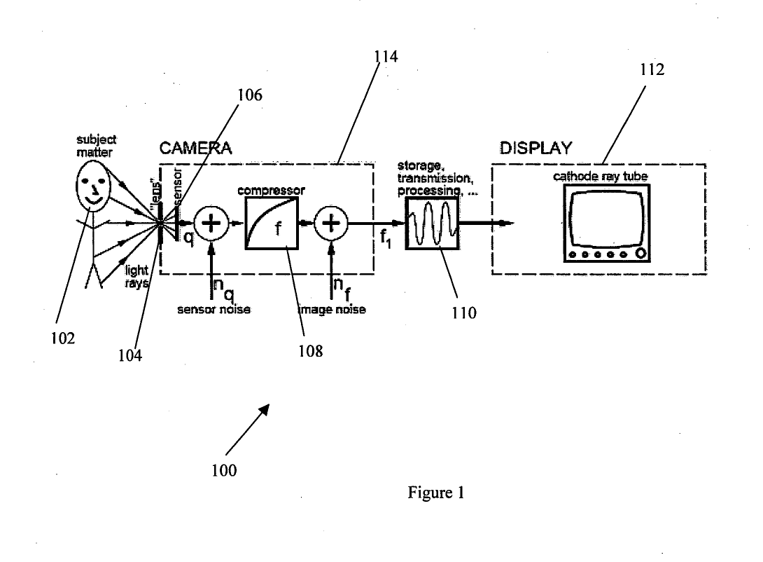

FIG. 1 illustrates a schematic block diagram of a range compression process 100 which transform images from the RGB space to the HSV space prior to processing. In FIG. 1, light rays from a subject 102 passes through the lens 104 of a camera 114. The light rays are then detected by the sensor 106 in the camera 114 to form an image. The image captured by the sensor 106 is subject to sensor noise (nq). Range compression of the image is then carried out in compressor 108. Before the image is output, file compression of the image, for example, JPEG compression may be performed giving rise to image noise (nf). The dynamically range compressed image is then stored, transmitted or processed in unit 110. The image is then transmitted to a display unit 112.

In most display units such as the cathode ray tube, the image is inherently distorted whereby this distortion can be modelled by a non-linear function such as an exponential function. Such a distortion, also known as a non-linear gamma correction, invariably exists in order to maintain backward compatibility with previous types of display units. Although the non-linearity may be adjusted in LCD displays, instead of using this control to correct for the non-linearity, the non-linearity is typically amplified to improve the contrast in most LCD displays. Hence, it is preferable that the camera 114 includes the compressor 108 which applies a range compression function f to the image so as to offset the inherent distortion of the image in the display unit 112. As mentioned before, the hue value for two images having different exposure times would be the same only if f is linear as shown in Equation (4).

However, the inventors have recognized that f is typically not linear, as mentioned above. Because of the non-linearity in the camera's output and that the data recorded from the camera is a non-linear representation of the photometric quantity of light falling on the sensor array, the notion of separating the luminance from the chrominance (which motivates an RGB to HSV type of transformation) is lost. Since the exposure time should simply change the luminance of the observed image and not affect its chrominance, the saturation and the hue components should remain unchanged. The inventors have recognised that this is not the case with the presence of the non-linear range compression function f, as described above. Example embodiments of the invention exploit a linearization of the camera's output data.

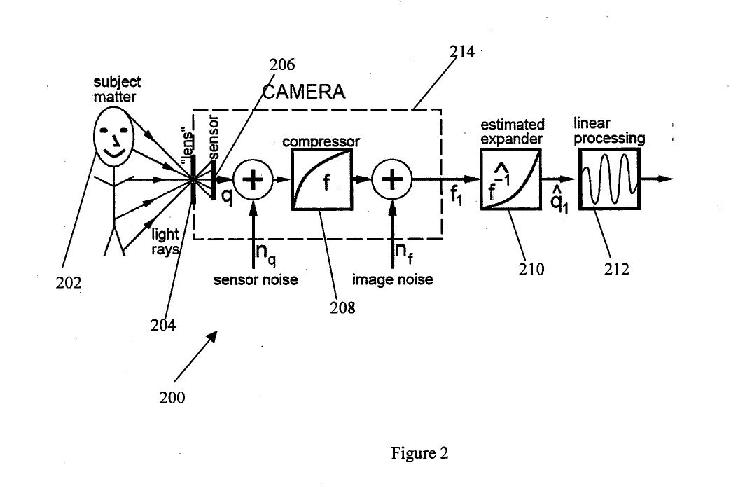

FIG. 2 illustrates a schematic block diagram of a range compression process 200 according to an embodiment of the present invention. In FIG. 2, light rays from a subject 202 passes through the lens 204 of a camera 214. The light rays are then detected by the sensor 206 in the camera 214 to form an image. The image captured by the sensor 206 is subject to sensor noise (nq). Range compression of the image is then carried out in compressor 208. Before the image is output, file compression of the image, for example, JPEG compression may be performed giving rise to image noise (nf). The range of the image is then expanded in the estimated expander 210 before linear processing in unit 212.

In one example, the estimated expander 210 uses the inverse of the range compression function f i.e. f⁻¹, assuming that this inverse exists. f⁻¹ is applied to the pixel values prior to the hue and saturation computations. Using this approach, the hue calculation for a first image is as shown in Equation (5).

$${H}_{1} = \{ \begin{matrix}0 & if max = min \\ {60}^{o} \times \frac{\begin{matrix}{f}^{- 1} ( f ( g ) ) - \\ {f}^{- 1} ( f ( b ) )\end{matrix}}{\begin{matrix}{f}^{- 1} ( f ( max ) ) - \\ {f}^{- 1} ( f ( min ) )\end{matrix}} + {0}^{o} & if max = f ( r ) and f ( g ) \geq f ( b ) \\ {60}^{o} \times \frac{\begin{matrix}{f}^{- 1} ( f ( g ) ) - \\ {f}^{- 1} ( f ( b ) )\end{matrix}}{\begin{matrix}{f}^{- 1} ( f ( max ) ) - \\ {f}^{- 1} ( f ( min ) )\end{matrix}} + {360}^{o} & if max = f ( r ) and f ( g ) < f ( b ) \\ {60}^{o} \times \frac{\begin{matrix}{f}^{- 1} ( f ( g ) ) - \\ {f}^{- 1} ( f ( r ) )\end{matrix}}{\begin{matrix}{f}^{- 1} ( f ( max ) ) - \\ {f}^{- 1} ( f ( min ) )\end{matrix}} + {120}^{o} & if max = f ( g ) \\ {60}^{o} \times \frac{\begin{matrix}{f}^{- 1} ( f ( r ) ) - \\ {f}^{- 1} ( f ( g ) )\end{matrix}}{\begin{matrix}{f}^{- 1} ( f ( max ) ) - \\ {f}^{- 1} ( f ( min ) )\end{matrix}} + {240}^{o} & if max = f ( b )\end{matrix} \qquad ( 5 )$$

Assuming that f(max)=f(r), f(g)≧f(b) and f(min)=f(b), H₁ is calculated according to Equation (6).

$${H}_{1} = {60}^{o} \times \frac{{f}^{- 1} ( f ( g ) ) - {f}^{- 1} ( f ( b ) )}{{f}^{- 1} ( f ( r ) ) - {f}^{- 1} ( f ( b ) ) } = {60}^{o} \times \frac{g - b}{r - b} \qquad ( 6 )$$

In a second image with a different exposure time whereby k is the ratio of the second image's exposure time to the first image's exposure time, the hue component of the second image is given by Equation (7). With the introduction of the inverse function f⁻¹, H₁ is equal to H₂ i.e. the hue components of two images with different exposure times are the same.

$$\begin{matrix}{H}_{2} = {60}^{o } \times \frac{{f}^{- 1} ( f ( kg ) ) - {f}^{- 1} ( f ( kb ) )}{{f}^{- 1} ( f ( kr ) ) - {f}^{- 1} ( f ( kb ) )} \\ = {60}^{o} \times \frac{kg - kb}{kr - kb} \\ = {60}^{o} \times \frac{k ( g - b )}{k ( r - b )} \\ = {60}^{o} \times \frac{g - b}{r - b} \\ = {H}_{1}\end{matrix} \qquad ( 7 )$$

Similarly, Equation (8) shows the saturation component for an image when the inverse of the range compression function f, i.e. f⁻¹, for each pixel is used.

$${S}_{1} = \{ \begin{matrix}0 & if {f}^{- 1} ( f ( max ) ) = 0 \\ ⌊ \frac{{f}^{- 1} ( f ( max ) ) - {f}^{- 1} ( f ( min ) )}{{f}^{- 1} ( f ( max ) )} ⌋ * max Value & \end{matrix} \qquad ( 8 )$$

It must be noted that given the requirement of light intensity invariance in skin detection tasks, the intensity calculation is not required and the intensity component is dropped after the RGB to HSV computation. The dimensionality of the colour space of the original RGB image hence reduced from I³ to R² by dropping the intensity component V.

Equations (6)-(8) show that the saturation and hue components remain the same for two images with different exposure times after the estimated expander 210 is included prior to the computation of the hue and saturation components. This in turn shows that the expansion of the rearrange compression function i.e. inclusion of the inverse function f⁻¹ and the linearization of the pixels to be brought to photometric values can effectively separate the luminance component from the chrominance in the RGB to HSV transformation. With the luminance component effectively separated from the chrominance, the consequent colour analysis can be advantageously simplified in the example embodiments.

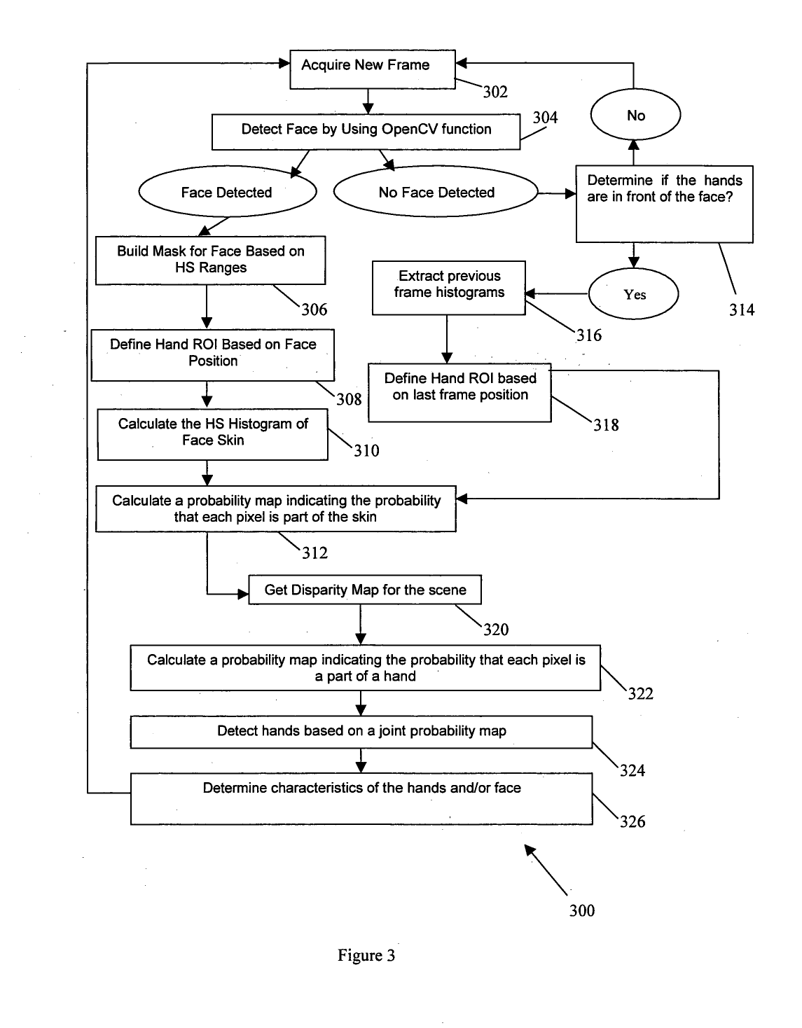

FIG. 3 shows a flowchart illustrating a method 300 for tracking hands according to an embodiment of the present invention. The system in the example embodiments starts running without a skin-colour model. A new frame is acquired in step 302. In order to initialize and maintain the skin-colour model automatically, Intel's open source library (OpenCV) is used to search and detect the user's face in each frame in step 304. In one example, step 304 uses the Viola and Jones classification algorithm.

To extract the skin colour information, the output of the camera is first linearized using a look-up table (LUT) derived from the tonal calibration of the camera as described earlier on in Equations (7)-(8). When this calibration is not possible, an approximate response function is used. Then the data from the detected face region is converted from the RGB format to the HSV format.

If a face is detected in step 304, a mask is then built for the face regions in step 306 based on the HS ranges in these regions. For example, in the detected face region, there are naturally some non-skin colour areas, such as the eyes, eyebrows, mouth, hair and the background. The HS values of these areas are far away from the HS values in the skin colour area within the HS space and are hence applied a mask. This leaves only the “fleshy” areas of the face to contribute to the HS histogram.

In step 308, the hand Region of Interest (ROI) is defined based on the face position. In one example, when the user is facing the system, it is assumed that the right hand is on the right side of the image and the left hand is on the left side of the image. The horizontal aspect of the ROI for the right (or left) hand is then taken to be the right (or left) side of the image starting slightly from the right (or left) of the face to the right(or left) edge of the camera's image. The vertical aspect of the ROI of both hands starts from just above the user's head to the bottom of the image. In one example, with these ROIs defined, the subsequent joint probability map computed can be reduced by masking the region outside the ROIs to zero.

In step 310, the HS histogram of the skin on the face is obtained. In one example, the HS histogram is computed according to the description below. Assuming that the image, I, has width=w and height=h and that after the hue and saturation computation, each pixel in the image has an illumination invariant hue and saturation value, S(I_{x,y}) is the saturation component for the pixel in the location row=x and column=y and correspondingly, H(I_{x,y}) is the hue component for the same pixel location. Considering a subset of pixels ψ from the image I which are from a part of the image detected as the face, a HS histogram can be constructed by using an appropriate quantization of the hue and saturation values. In one example, the histogram is of size 120×120 whereby this size has been proven to be effective via testing. However, this quantization can easily be changed. By setting maxValue in the calculation of the saturation to an appropriate value, the hue and the saturation components can be quantized into discrete values whereby the number of discrete values is equal to maxValue. The quantization of the hue (H) component to give the quantized value Ĥ is given in Equations (9). For example, choosing maxValue as 120 will quantize each of the hue values into one of 120 discrete values.

$$\hat{H} = \frac{H}{360} \times max Value \qquad ( 9 )$$

In the example embodiments, to construct a histogram K of dimension maxValue×maxValue, an indicator function δ is first defined in Equation (10).

$$δ ( x , {x}^{′} , y , {y}^{′} ) = \{ \begin{matrix}1 & if x = {x}^{′} and y = {y}^{′} \\ 0 & otherwise\end{matrix} \qquad ( 10 )$$

Then the two-dimensional histogram K with indices 0≦i<maxValue and 0≦j<maxValue may be defined according to Equation (11). In Equation (11), w is the width and h is the height of the image I.

$${K}_{i , j} = {\sum }_{s = 0}^{ω - 1} {\sum }_{t = 0}^{h - 1} δ ( \hat{H} ( {ψ}_{s , t} ) , i , S ( {ψ}_{s , t} ) , j ) \qquad ( 11 )$$

In one example, the HS histogram of the new frame obtained according to Equation (11) is added to a set of previously accumulated histograms. In this example, to provide added robustness and stability to the model, a record of previous histograms is kept. Furthermore, when one (or both) of the users' hands have been previously detected, this information can be used to supplement the skin-tone model, in order to increase the robustness of the system. The final histogram can then be an aggregate of the previous histograms collected. For example, this history can extend back over a finite and small region, approximately 10 frames, allowing for adaptability and changes in users, lighting, changes in camera parameters, etc., while still gaining performance benefits from signal averaging and increased sample data.

In step 312, a probability map indicating the probability that each pixel in the image is a part of the skin is calculated by transforming the histogram obtained at the end of step 310. The histogram is first transformed into a probability distribution through normalization, specifically according to Equation (12) whereby T is given by Equation (13). In Equation (12), \hat{K}_{i,j} is the normalized histogram which can also be termed the probability distribution.

$$\begin{matrix}{\hat{K}}_{i , j} = \frac{{K}_{i , j}}{T} & ( 12 ) \\ T = {\sum }_{i = 0}^{maxValue} {\sum }_{j = 0}^{ma xValue} {K}_{i , j} & ( 13 )\end{matrix}$$

After obtaining the normalized histogram in Equation (12), given a light intensity invariant skin model, the probability distribution in the example embodiments can then be back projected onto the image in HS space yielding a probability map according to Equation (14). The ROIs for the left and right hands, where regions outside of the ROIs are masked to zero in the probability map, are used in the example embodiments in the back projection of the normalized histogram. The back projection can be limited to candidate regions of the input image corresponding to the ROIs hence reducing computation time. This back projection of the skin colour region onto the candidate regions of the input image can produce adequate probability maps when used to detect skin regions since the skin colour regions of the face and the hand almost overlap with each other.

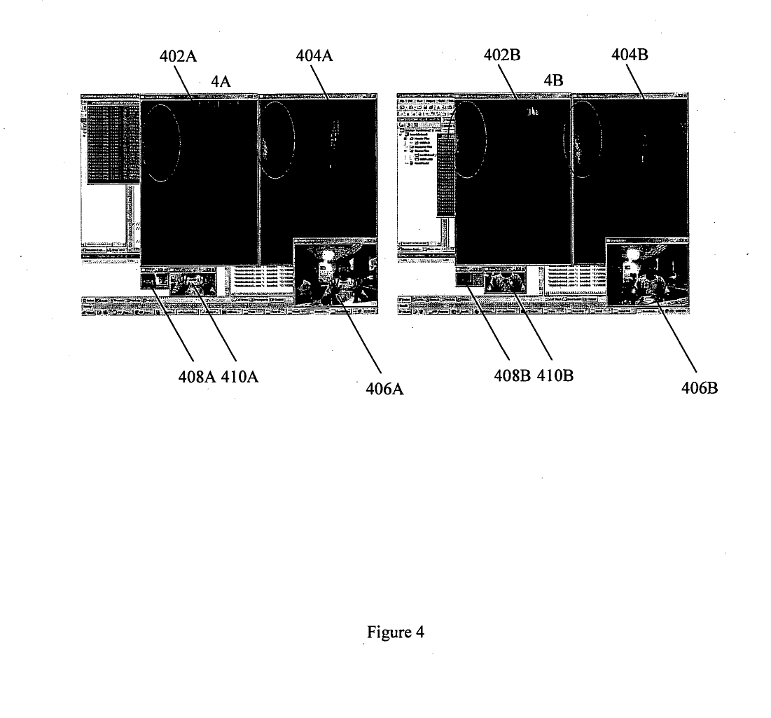

This can be seen in FIGS. 4A and 4B which show the HS histograms of the hands and faces from subject 1 and subject 2 respectively according to an embodiment of the present invention. Note that in FIGS. 4A and 4B, the left plots 402A and 402B correspond to the HS histograms of the hands, and the right plots 404A and 404B correspond to the HS histograms of the faces. The camera images 406A and 406B are shown on the bottom right of FIGS. 4A and 4B respectively. The face and hand regions for each of these camera images are then manually extracted and these are shown on the bottom left of FIGS. 4A and 4B. Images 408A and 408B correspond to the face regions whereas images 410A and 410B correspond to the hand regions. HS histograms for these skin regions are then calculated and are shown using gray-scale intensities on a 2D format in plots 402A, 402B, 404A and 404B such that a lighter point in the histogram corresponds to a higher count of the histogram bin. In FIGS. 4A and 4B, a human's face and hand is shown to have a similar skin colour region in the HS space as the skin colour regions of the hand and the face are both at the upper left part of the HS histrograms in FIGS. 4A and 4B and almost overlap with each other. Other parts of the HS histograms in FIGS. 4A and 4B come from the non skin-colour areas.

The probability map M_{i,j} obtained at the end of step 312 indicates the probability that the pixel i,j in the image corresponds to skin.

M_{i,j}=\hat{K}_{H(I(i,j),S(I(i,j)))} (14)

If no face is detected, in step 314, it is determined if the hands are in front of the face by checking if the ROI of the hands was close to the ROI of the face in a previous frame. If the hands are not detected in the previous frame, this step is omitted and the algorithm starts from step 302 again. If it is determined that the hands are not in front of the face, a new frame is acquired and the algorithm starts from step 302 again. If the hands are in front of the face, histograms of previous frames are extracted in step 316. The hand ROI is then defined based on its ROI position in the previous frame in step 318. Steps 314, 316 and 318 allow the hand ROI to be defined when the face is not detected in situations such as when the hands occlude the face.

Step 312 is performed after step 318. If no face is detected, in step 312, a probability map indicating the probability that each pixel in the image is a part of the skin is calculated using the normalized previous frame histogram as obtained in Equation (12) i.e. the previous frame probability distribution. In step 312, this probability distribution from the previous frame is back projected onto the current image in HS space to yield the probability map. The ROIs for the hands, where regions outside of the ROIs are masked to zero in the probability map, are used in the example embodiments in the back projection of the normalized previous frame histogram. The back projection can be limited to candidate regions of the input image corresponding to the ROIs hence reducing computation time.

Using a stereo camera in the example embodiments, it is possible to get depth information based on pixel disparities resulting from the two cameras of the system having differing spatial locations. Hence, in step 320, a disparity map is calculated for the scene. In one example, a commercially available library, which comes with the stereo camera, is used to calculate a dense disparity map made up of pixel-wise disparity values.

In step 322, the probability that each pixel in the image is part of a hand is computed given distance between the pixel and the camera. For the task of tracking hands, given that a user is facing an interactive system and the camera system, one assumption that can be made is that it is likely that the user's hands are in front of his or her face. In the example in FIG. 3, the average distance between the face and the camera is calculated and the potential hand candidates whose distances are further away from the camera than the face are discarded since objects which are detected as further away from the camera than the face are considered as having a zero probability of being a hand. It is also reasonable that the closer an object is to the system, the more likely it is to be one of the user's hands. Thus, in considering an appropriate probability function, two distances are considered in the example embodiments. The first is d_{face} i.e. the distance of the user's face to the camera system and the second is hardware dependent dₘᵢₙ, the minimum distance that an object can be to the camera, for which the system is still able to approximate a depth. In the example embodiments, if no face is detected in the current frame, the value of d_{face} from the previous face is used. Assuming that negative distances are not achievable, the probability of a pixel being from a hand given its distance D from the camera, Pr(H|D), is given by Equation (15) whereby ΔD is given by Equation (16). In this example, the probability of a pixel being part of a hand i.e. a hand probability increases linearly as the pixel moves towards the camera.

$$\begin{matrix}Pr ( H \vert D ) = \frac{2}{{d}_{face} + {d}_{m i n}} \cdot Δ ( D ) & ( 15 ) \\ Δ ( D ) = \{ \begin{matrix}1 & if D > {d}_{face} \\ 0 & if D < {d}_{m i n} \\ \frac{{d}_{face} - D}{{d}_{face} - {d}_{m i n}} & Otherwise\end{matrix} & ( 16 )\end{matrix}$$

Considering the output of a stereo camera, a depth or disparity map as obtained in step 320 can be used to convert the probability Pr(H|D) into a probability map, where each discrete point in the map N is a hand probability given the detected distance. Equation (17) shows this conversion whereby η is the disparity map. The probability map N_{i,j} indicates the probability that the pixel i,j in the image corresponds to a part of a hand given its approximated distance to the camera system.

N_{i,j}=Pr(H|η_{i,j}) (17)

In step 324, the hands of the user are detected based on a joint probability map obtained by combining the probability map M obtained in step 312 (Equation 14) and the probability map obtained in step 322 (Equation 17). The dimensions of the probability map M and the probability map N are identical and the joint probability map P indicates the probability of a pixel being a hand given its depth and colour. P is given by Equation (18) whereby P is the Hadamard product of M and N.

P_{i,j}=M_{i,j}×N_{i,j} (18)

In the example embodiments, to find the hand positions as well as the smallest rectangle containing each hand, the CamShift algorithm is used. This CamShift algorithm is provided by the OpenCV library and contains a weight output that is used as a detection threshold to be applied on the joint probability map in the example embodiments. Using the CamShift algorithm, the central point of the rectangle around each of the probability masses along with the angle of each of the probability masses in the joint probability map are computed. Together with the information of the central point in the previous frame, the position of each hand in X, Y and Z axes as well as the angle of each hand is calculated. In one example, the position of the face in the X, Y and Z axes is also calculated.

Furthermore, if a hand was detected in previous frames, this information can also contribute to a joint probability measure in step 324 in one example. To implement this history criterion, a mask can be applied over the joint probability map P, centered on the last hand position. In one example, a Gaussian-type mask is applied to the last known hand locations. In another example, a square mask can be used. Using a square mask can decrease the computation time of the system greatly and at the same time, achieve favorable results. The size of the square mask in the example embodiments can be determined by the frame rate of the camera along with a maximum speed the hand may achieve over consecutive frames.

In another example, the system is further configured to detect both hands, with a starting assumption that the left hand is on the left side of the face and the right hand is on the right side of the face in step 314.

In step 326, characteristics of the hands and/or face are obtained. In one example, these characteristics include the direction and velocity of motion of the hands and face which can be calculated using neighboring frames. These characteristics may also include the shape or depth of the hand or the colour information of the hand. These information can also be added to the histogram information.

The advantages of the embodiments in the present invention include:

In the example embodiments, the camera is tonally calibrated to aid in the transformation of images from the RGB to the HSV space. Any non-linearities in the camera's output given the input recorded are recovered and corrected for before the HSV transformation is done. This non-linear correction can allow data from the camera i.e. pixels to be recorded in a perceptually meaningful manner. In many cameras, this can be of significant importance as the camera response function is usually non-linear and the importance of correcting the non-linearities in the camera's output hence depends on how far the camera response function strays from being linear. Furthermore, non-linear gamma-correction is often used to compensate for the non-linearity present in display devices. Also, through the use of f⁻¹ in the example embodiments, the probability map obtained will be robust to differences in intensity as the unwanted effect of lighting difference effecting for example, tracking of hands, will be nullified.

In the example embodiments, the HS histogram is in itself a two-dimensional probability distribution which may be projected to each pixel in an image to produce a skin-likeness probability for the pixel. In addition, the depth information is also treated as a probability distribution. In this case, the probability of a depth is linearly mapped such that disparity information indicating content which is behind the user's face is zero but increases to one linearly as the content gets closer to the camera. Since one would usually expect the user's hands to be the closest content to the camera, this technique is quite intuitive and can give two “probability maps” instead of one. These two “probability maps” include one for depth information and another for pixel colour information. In the example embodiments, the joint probability of these two functions is used by employing point-wise multiplication (Hadamard). Tests have shown the method in the example embodiments to be more effective than other methods in the prior arts such as [S. Grange, E. Cassanova, T. Fong, and C. Baur., “Vision-based sensor fusion for Human-Computer Interaction”, IEEE International Conference on Intelligent Robots and Systems, Lausanne, Switzerland, 2002.]. More particularly, the prior art uses depth as a filter i.e. a binary value which is either 0 or 1 to remove the regions belonging to the background that has the same colour as the user's skin whereas the example embodiments in the present invention use depth as a probability measure with a continuous value between 0 and 1.

Furthermore, not only can the system in the example embodiments use temporal motions as an input, it can also use the position of the hands relative to the face to provide input to an application. For example, if the system is used to control a video game, the user raising both arms above the face can indicate that the user intends to move his or her position upwards. Similarly, when the user moves his or her hands to the right of the face, it can indicate an intention to move his or her position rightwards. In one example, various hand positions can also be used for rotations of the user's positions.

In the example embodiments, by using the distance information in the computation of the hand probability map, the system can detect hand motions in public places with a complex and moving background in real-time. These example embodiments can be used in many applications. For example, they can be used in an interactive kiosk system whereby the user can see a 3D map of the campus and interact with it through voice and gestures. Via this interaction, the user can obtain information about each of the places on the 3D map. Another example of an application in which the example embodiments can be used is in an advertisement. The advertisement can be in the form of an interactive system that grabs the users' attention and shows them the advertised products in an interactive manner. Furthermore, example embodiments in the present invention can also be used in tele-rehabilitation applications whereby the patient sitting in front of a display at home is instructed by the system on how to move his hand. Example embodiments of the present invention can also be used in video games as a new form of interface.

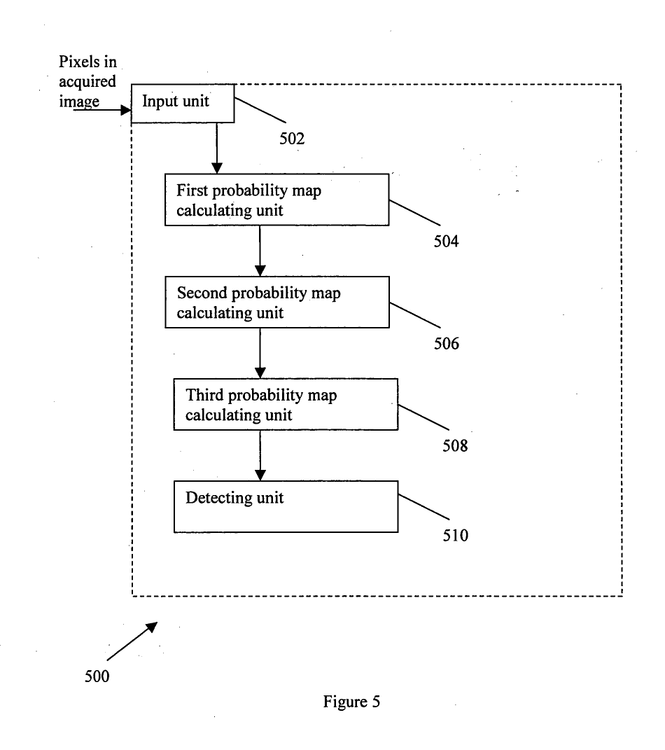

FIG. 5 shows a schematic block diagram of a system 500 for detecting and tracking hands in an image according to an embodiment of the present invention. The system 500 includes an input unit 502 to receive the pixels in an acquired image, a first probability map calculating unit 504 for calculating a first probability map comprising of probabilities that respective pixels in the image corresponds to skin based on colour information associated with the respective pixels, a second probability map calculating unit 506 for calculating a second probability map comprising of probabilities that the respective pixels in the image corresponds to a part of a hand based on depth information associated with the respective pixels, a third probability map calculating unit 508 for calculating a joint probability map by combining the first probability map and the second probability map and a detecting unit 510 for detecting and tracking hands in the image using an algorithm with a weight output as a detection threshold applied on the joint probability map.

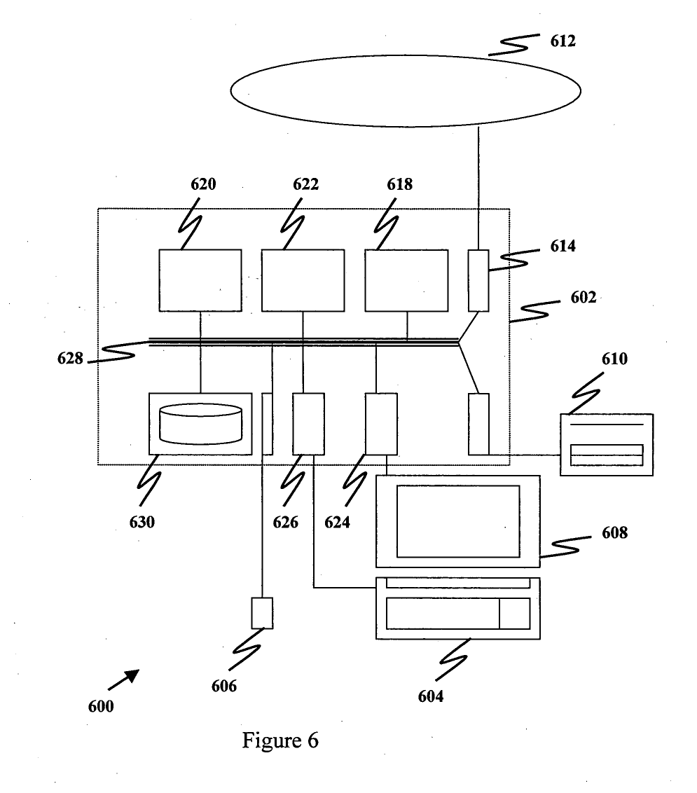

The method and system of the example embodiment can be implemented on a computer system 600, schematically shown in FIG. 6. It may be implemented as software, such as a computer program being executed within the computer system 600, and instructing the computer system 600 to conduct the method of the example embodiment.

The computer system 600 comprises a computer module 602, input modules such as a keyboard 604 and mouse 606 and a plurality of output devices such as a display 608, and printer 610.

The computer module 602 is connected to a computer network 612 via a suitable transceiver device 614, to enable access to e.g. the Internet or other network systems such as Local Area Network (LAN) or Wide Area Network (WAN).

The computer module 602 in the example includes a processor 618, a Random Access Memory (RAM) 620 and a Read Only Memory (ROM) 622. The computer module 602 also includes a number of Input/Output (I/O) interfaces, for example I/O interface 624 to the display 608, and I/O interface 626 to the keyboard 604.

The components of the computer module 602 typically communicate via an interconnected bus 628 and in a manner known to the person skilled in the relevant art.

The application program is typically supplied to the user of the computer system 600 encoded on a data storage medium such as a CD-ROM or flash memory carrier and read utilising a corresponding data storage medium drive of a data storage device 630. The application program is read and controlled in its execution by the processor 618. Intermediate storage of program data maybe accomplished using RAM 620.

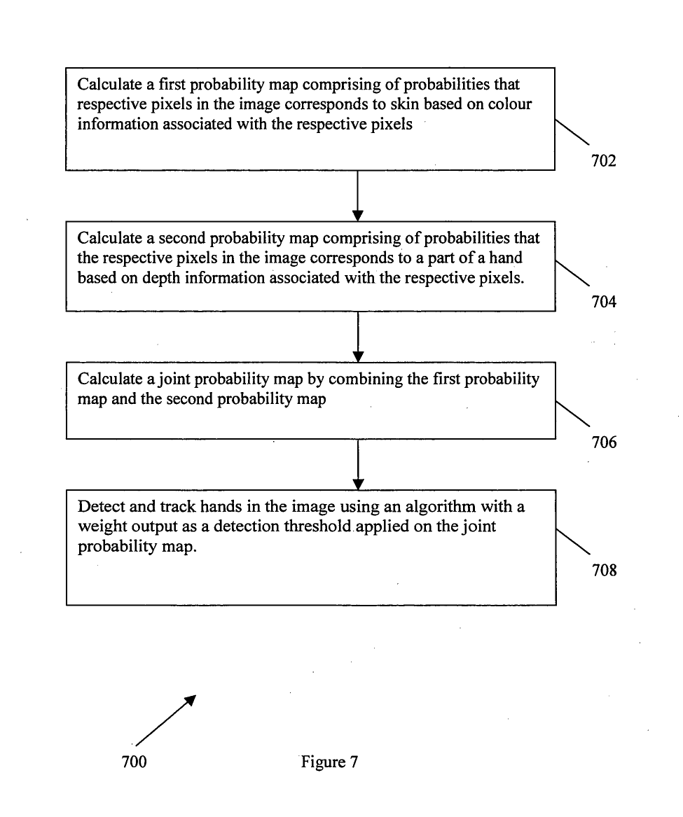

FIG. 7 shows a flowchart illustrating a method 700 for detecting and tracking hands in an image according to an embodiment of the present invention. In step 702, a first probability map comprising of probabilities that respective pixels in the image corresponds to skin based on colour information associated with the respective pixels is calculated. In step 704, a second probability map comprising of probabilities that the respective pixels in the image corresponds to a part of a hand based on depth information associated with the respective pixels is calculated. In step 706, a joint probability map by combining the first probability map and the second probability map is calculated and in step 708, hands in the image are detected and tracked using an algorithm with a weight output as a detection threshold applied on the joint probability map.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for detecting and tracking hands in an image, the method comprising the steps of:
calculating a first probability map comprising of probabilities that respective pixels in the image corresponds to skin based on colour information associated with the respective pixels;
calculating a second probability map comprising of probabilities that the respective pixels in the image corresponds to a part of a hand based on depth information associated with the respective pixels;
calculating a joint probability map by combining the first probability map and the second probability map; and
detecting and tracking hands in the image using an algorithm with a weight output as a detection threshold applied on the joint probability map.

2. The method as claimed in claim 1, wherein the step of calculating a first probability map comprising of probabilities that respective pixels in the image correspond to skin based on colour information associated with the respective pixels further comprises the steps of:
detecting a face in the image;
calculating hue and saturation values of the respective pixels in the image;
quantizing the hue and saturation values calculated;
constructing a histogram by using the quantized hue and saturation values of the respective pixels in a subset of pixels from a part of the detected face;
transforming the histogram into a probability distribution via normalization; and
back projecting the probability distribution onto the image in the hue/saturation space to obtain the first probability map.

3. The method as claimed in claim 2, wherein the step of calculating hue and saturation components of the respective pixels in the image further comprises the step of applying the inverse of a range compression function to the respective pixels in the image.

4. The method as claimed in claim 2, further comprising the step of building a mask for the detected face prior to using the subset of pixels from a part of the detected face to construct the histogram, wherein the mask removes pixels not corresponding to skin from the subset of pixels.

5. The method as claimed in claim 2, further comprising the step of adding the constructed histogram to a set of previously constructed histograms to form an accumulated histogram prior to transforming the histogram into a probability distribution via normalization.

6. The method as claimed in claim 1, further comprising the steps of:
defining the horizontal aspect of a ROI of a right hand to be the right side of the image starting slightly from the right of the face to the right edge of the image;
defining the horizontal aspect of a ROI of a left hand to be the left side of the image starting slightly from the left of the face to the left edge of the image; and
defining the vertical aspect of a ROI of both hands to be from just above a head containing the face to the bottom of the image; and
the back projecting of the probability distribution onto the image in the hue/saturation space to obtain the first probability map is performed onto candidate regions of the image corresponding to the ROI.

7. The method as claimed in claim 1, wherein if a face is not detected, the method further comprises the steps of:
checking if the hands are detected in a previous frame;
checking if a ROI of the hands is close to a ROI of the face in the previous frame;
defining a ROI of the hands in a current frame based on the ROI of the hands in the previous frame if the hands are detected in the previous frame and if the ROI of the hands are close to the ROI of the face in the previous frame; and
the back projecting of the probability distribution onto the image in the hue/saturation space to obtain the first probability map is performed onto candidate regions of the image corresponding to the ROI of the hands in the current frame.

8. The method as claimed in claim 1, wherein the step of calculating a second probability map comprising of probabilities that the respective pixels in the image corresponds to a part of a hand based on depth information associated with the respective pixels further comprises the steps of:
calculating a first distance, d_{face}, between a face and a camera;
calculating a second distance, dₘᵢₙ, wherein the second distance is the minimum distance an object can be from the camera;
calculating a third distance, D, between the respective pixels in the image and the camera;
calculating a probability of zero if D is greater than d_{face}, a probability of one if the D is less than dₘᵢₙ and a probability of (d_{face}−D)/(d_{face}−dₘᵢₙ) otherwise for the respective pixels in the image;
normalizing the calculated probability by multiplying said calculated probability by (2/(d_{face}+dₘᵢₙ) for the respective pixels in the image;
calculating pixel disparity values resulting from a plurality of cameras having differing spatial locations; and
converting the normalized probability into a probability that the respective pixels in the image corresponds to a part of a hand using the pixel disparity values to form the second probability map.

9. The method as claimed in claim 1, wherein the step of calculating a joint probability map by combining the first probability map and the second probability map further comprises the step of multiplying the first probability map and the second probability map by using Hadamard product.

10. The method as claimed in claim 1, the method further comprising the step of applying a mask over the joint probability map prior to detecting hands in the image, wherein the mask is centered on a last known hand position.

11. The method as claimed in claim 1, wherein the step of detecting and tracking hands in the image using the algorithm with a weight output as a detection threshold applied on the joint probability map further comprises the steps of:
calculating a central point of a rectangle around each of a probability mass along with the angle of each of a probability mass in the joint probability map in this frame; and
calculating a position of each of the hands in the X, Y and Z axes as well as the angle of each hand using the calculated central point and calculated angle in this frame, and the calculated central point in the previous frame.

12. The method as claimed in claim 1, the method further comprising the step of calculating the direction and velocity of motion of the detected hands using the positions of previously detected hands and the positions of following detected hands.

13. A system for detecting and tracking hands in an image, the system comprising:
a first probability map calculating unit for calculating a first probability map comprising of probabilities that respective pixels in the image corresponds to skin based on colour information associated with the respective pixels;
a second probability map calculating unit for calculating a second probability map comprising of probabilities that the respective pixels in the image corresponds to a part of a hand based on depth information associated with the respective pixels;
a third probability map calculating unit for calculating a joint probability map by combining the first probability map and the second probability map; and
a detecting unit for detecting and tracking hands in the image using an algorithm with a weight output as a detection threshold applied on the joint probability map.

14. The system as claimed in claim 13, the system further comprising an expander for applying the inverse of a range compression function to the respective pixels in the image.

15. A non-transitory data storage medium having stored thereon computer code means for instructing a computer system to execute a method for detecting hands in an image, the method comprising the steps of:
calculating a first probability map comprising of probabilities that respective pixels in the image corresponds to skin based on colour information associated with the respective pixels;
calculating a second probability map comprising of probabilities that the respective pixels in the image corresponds to a part of a hand based on depth information associated with the respective pixels;
calculating a joint probability map by combining the first probability map and the second probability map; and
detecting and tracking hands in the image using an algorithm with a weight output used as a detection threshold applied on the joint probability map.
